(19) United States
(12) Patent Application Publication
(10) Pub. No.: US 2019/0151772 A1
(43) Pub. Date: May 23, 2019

(54) Solvent extraction equipment, which allows efficient use of energy, through the reuse of the solvent(s).

(71) Applicants: Maximiliano Andres Pino Orellana, Santiago (CL); Sociedad de Ingenieria Ambiental Ltda., Santiago (CL)

(72) Inventor: Maximiliano Andres PINO ORELLANA, Santiago (CL)

(21) Appl. No.: 16/198,353

(22) Filed: Nov. 21, 2018

Related U.S. Application Data
(60) Provisional application No. 62/589,813, filed on Nov. 22, 2017.

(51) Int. Cl. B01D 11/02; C09B 61/00

(52) U.S. Cl. CPC B01D 11/0296; C09B 61/00; B01D 11/0207; B01D 11/0219

(57) ABSTRACT

Solvent extraction equipment (30), which allows efficient use of energy, through reuse of the solvent(s), with greater penetration and subsequent extraction of the compounds, increasing the amount of product obtained comprising: an upper body (2) container of an extraction source or solid material to be extracted; a lid (1) that joins the upper body (2) wherein the lid (1) comprises: a connection (19) to a condenser, an extractant solvent charging connector (20), an extractant solvent charging valve (21) and a condensate diffusion and non-drip system (23); a lower body (3) container of the solvent/extract, comprising: a lower heating sleeve (6l); which comprises a means of temperature control; an inner chamber (3A) that is inside the lower heating sleeve (6l), comprising a connection valve to a vacuum and aeration connection subsystem (10) and a solvent loading valve (11), wherein the lower part of the inner chamber (3A) comprises a lower outlet pipe (9) passing through the lower heating sleeve (6l) at its lower part, where the lower outlet pipe (9) comprises a solvent/extract shut-off valve (8); and a lower flange (12l) joining the lower part of the upper body (2) to the upper part of the lower body (3) container of the solvent/extract, wherein the lower flange (12l) further comprises a lower seal (18l) and a filter element (17); associated system and method.

### CROSS REFERENCE TO RELATED APPLICATION

This application claims the benefit of priority of U.S. Provisional Patent Application No. 62/589,813, filed on Nov. 22, 2017, application which is incorporated herein in its entirety for all purposes.

### FIELD OF THE INVENTION

The present invention relates to an equipment, system and method of extraction, which allows to separate and obtain compounds from solid raw materials (solid sources of extraction or solid matrices) from the industry of the primary and secondary sector, where the compounds can be antioxidants, pigments, flavorings, molecules with active principles, fatty acids, essential oils, among others, through the use of various types of solvents or mixtures of these.

This invention relates to an equipment, system and method of extraction using solvents in a closed system, which allows efficient energy use, reuse of the solvent(s), reducing extraction times and the increase in the amount of product obtained. In addition, with this equipment, system and method of extraction, products are obtained with a better coloration, with more intense colors and a greater amount of final product as, for example, fat (oil) in comparison to the known and conventionally used systems. On the security side, the present equipment and system allows the stopping of the operation at any time, avoiding accidents and burns due to overpressure, since it is allowed to reduce said pressure and decrease the temperature of the extraction equipment at any time during the operation.

Currently, in the industry of the primary and secondary sector there are numerous compounds of commercial interest that present a biological activity, and can be used as supplements and additives in the pharmaceutical, cosmetic, nutraceutical and food industries, in addition to their application in some technological uses. In general, these types of compounds are present in low concentrations, which even, due to the technical management complications or the lack of knowledge on the part of the companies, make their recovery difficult, relegating these possible products to be part of the waste and discards of the industry of the primary and secondary sector.

There are several technologies, equipment and methodologies that allow the recovery of these compounds, differing in their technical feasibility of application, efficiency and operating costs.

The present invention corresponds to an economically viable system, easy to use, which allows the recovery of compounds of interest and high added value from various solid extraction sources (matrix) from the industry of the primary and secondary sector, through efficient extractions with the use of solvents, facilitating the handling of raw materials, solvents, products and discards, due to the constructive characteristics of this system.

The products obtained will depend on the affinity of the compound(s) with the solvents used (water, alcohols, ketones, esters, alkanes, chlorinated, aromatics, solutions, among others) or the possible mixtures among them, being possible to perform successive extractions on the same solid source (matrix) with different types of solvents.

The purpose of this equipment, system and method is to allow, through a simple, economic and efficient methodology, the recovery, from solid sources, of different types of compounds of commercial interest such as antioxidants, pigments, flavorings, molecules with active ingredients, fatty acids, essential oils, among others.

### State of the art

At present, there are several reactors or extractors and methodologies that allow the recovery of compounds of interest from various sources, through the use of solvents of various types. These systems seek to perform the removal of some compound from sources or solid raw materials (which sometimes have no greater value or importance). The compound(s) of interest, can be found in low concentrations or be the only that really matters in said source, which makes necessary their recovery, subsequent purification and concentration to obtain products of high added value.

At present, there are various types of waste coming from the industry of the primary and secondary sector, or, in other words, the waste from transformation of natural resources into primary products or the transformation of these primary products into new products are those containing compounds of commercial interest that, due to the complex equipment and existing methodology, makes the implementation and their use for obtaining said compounds impractical. One of the simplest ways of recovery of these compounds of interest is through the extraction using solvents, to which the solid source that contains them (solid extraction source or matrix) is submitted. The great problem of solvents extraction is its high cost in equipment and the difficulties related to the handling of raw materials, solvents and waste.

The system of the present patent application allows the optimization of this type of extractions and recovery of the compounds of interest, with lower implementation cost and reduction of the extraction times, the use of smaller amounts of solvents, together with the reuse and recovery of these, allowing a lower cost/benefit ratio, which increases the feasibility of its implementation.

Among the best known equipment and methodologies we note the Soxhlet system, alembic system, contact system, extraction and supercritical fluid extraction, in addition to a number of apparatuses that exist in the prior art, for example, documents WO2014093573, EP1878479, WO2001017645, WO1996023565.

In general, the great difference between the various equipment together with their methodologies and the equipment of this invention is due to the effects and interactions involved in the extraction process.

Among the characteristics presented by this invention can be mentioned:
It corresponds to an isolated system, which prevents the emission of solvent vapors to the environment, due to the fact that the equipment retains the vapors generated through the use of condensers.
This equipment allows the recovery and concentration of the extract, as required.
This equipment can be kept closed and isolated from the loading stage of the solvent until the recovery of the concentrated product, including the extraction, concentration and recovery stages of the solvent.
Because this invention allows direct action of the solvent vapors on the solid extraction source, the extractive process becomes more efficient since it allows a greater and better penetration of the extractant solvent into the interstices of the solid material with an increase of the extraction, in relation to the penetration due to the solvent in liquid state. This allows obtaining a greater degree of extraction and finally a more concentrated product.
Due to its way of operating, this extractor presents superior performance in a shorter operating time compared to the most known extraction systems.
This invention allows the reuse of solvent in the extractive process, because:
   The solvent of the extract is re-evaporated and its vapors are incorporated again to the solid source, allowing its reuse in the extraction process.
   Once the extraction is finished, this equipment and its valve system allow the concentration of the extract (50) obtained, with the consequent recovery of the solvent, which can be used in a new extraction process.
Due to the feasibility of applying vacuum inside the system, it can be done:
   Lower temperature extractions, due to the decrease of the boiling point of the as a result of the decrease of pressure within the system, minimizing possible decompositions by temperature that some compounds may suffer.
   Decreasing the amount of oxygen present in the extractive process, avoiding unwanted reactions of oxidation and decomposition of any compound of interest.
   Once the extraction is finished, it allows partial drying of the source to which the extraction was performed, with the consequent recovery of part of the absorbed solvent.
Once the extraction process is finished, the system allows the entry of air for the partial or total drying of the solid material to which the extraction was made.
This extraction equipment can be manufactured in materials such as brass, steel, stainless steel, copper, glass, aluminum, among others and/or mixture thereof. Its production will depend on the extraction source, the compounds that will be required to extract and the solvents to be used due to the chemical compatibilities that may arise, as well as the temperature and pressure considerations that the system must reach.

### SUMMARY DESCRIPTION OF THE INVENTION

Due to the need to heat the system to produce the evaporation of the extractant solvent, the gaseous molecules generated acquire a greater kinetic energy, which, when in contact with the solid extraction source, penetrate its interstices, allowing a more intimate contact between the extractant solvent and the compound(s) of interest that are required to be extracted, while producing an energy transfer effect between the vapors of the solvent and the solid material, which leads to the condensation of part of the solvent and the heating of the group (solid source/solvent), facilitating the extraction by increasing the solubility of the compounds with temperature. Additionally, the part of the solvent vapors that do not reach to be condensed when it comes into contact with the solid material, produce a bubbling effect, which, mobilizes said solid as a stirring, allowing a more homogeneous and efficient extraction. The vapors that pass through this system are condensed and returned to the extractor on the solid material allowing its use in the process, which increases the extraction capacity. With this way of operating, greater extraction efficiencies are achieved, which improve even more, with the bubbling of the solvent that generates movement in the solid material, obtaining a more homogeneous and better contact between solvent vapors, condensate and extraction source, which also generates shorter operating times, with the natural consequence of energy savings.

Additionally, this type of extractor allows the reuse of the solvent. This is due to the fact that, in the extraction process, the extraction source is subjected to the vapors of pure solvent (extractant) and its subsequent condensation, which return in the form of an extract to the compartment containing the solvent. Subsequently, the re-evaporation of the solvent of the extract takes place, thus allowing a new extraction with the evaporated solvent that subsequently condenses in the solid source or in the condensation system with return on it, generating a new extraction.

This type of extractor also has a filter element (17) where the solid source to be extracted that allows the passage of the solvent and the dissolved material is supported, but prevents the passage of the solid material particles, thus avoiding its drag along with the extract towards the solvent/extract container (3). The transfer of the extract from the upper container (2) to the lower container (3) can be caused by: falling by gravity, cooling of the lower system causing a decrease in the pressure that allows the drag of the extract and, finally, the use of a vacuum system with connection to the lower container (10), which accelerates the drag process of the extract. For this last case, because the system is at boiling temperature of solvent, the vacuum system must be connected to a vapor condenser (31) connected to a condensed solvent accumulator (32) (similar to what is known to a vacuum filtration system with the use of a Büchner funnel and Kitasato flask connected to a gas trap). This recovered solvent may be returned to the system if the extraction process is continued or can be stored simply allowing the concentration of the extract (50) obtained. Once the extract has been recovered, the partial or total drying of the extraction source can be performed, by means of solvent vapor dragging with the use of vacuum or by the introduction of air currents.

This type of extractor allows the extraction and recovery of polar compounds by means of the use of water and/or alcohols or apolar compounds (fats, oils, etc.) by means of organic solvents, which are compatible with the equipment making material, wherein the temperature of the upper body (2) can be visualized by means of a thermocouple shown in the diagram. The temperature control can be accomplished by the amount of condensed vapors and the feeding and output temperatures for the condenser. This, due to the fact that it is an equipment that works with different solvents, the condensation temperatures will vary with the solvent used and with that the temperature with which the condenser will have to work, one way is by feeding the condenser at low temperatures (for example water at 15° C.) and if there is a significant increase in temperature at the outlet of this (for example 40° C.) and there is acetone in the system, this can be reduced with the increase of the condenser cooling flow by increasing the flow of refrigerant material (for example the water that enters and leaves the condenser).

The present equipment operates with stages or cycles: wherein the cycle comprises the evaporation of the solvent, condensation, extraction and return of the solvent with the solubilized material (extract) to the lower compartment. Then the evaporation process is repeated until the solvent/extract returns again.

### DESCRIPTION OF THE FIGURES

FIG. 1. This figure shows a two-stages extraction equipment, which consists of: a lid (1), upper body (2) container of the extraction source, lower body (3) container of the solvent/extract, solvent/extract inner container (3A), hot water, steam or some heating fluid inlet (4), air or water inlet (4S) for temperature control, return or outlet connection (5) of heating fluid, air or water outlet (5S) for temperature control, lower heating sleeve (6l), load level indicator (7), solvent/extract shut-off valve (8), solvent/extract outlet (9), connection valve to a vacuum and aeration connection subsystem (10), solvent loading valve (11), lower flange (12l), lower seal (18l), upper flange (12S), upper seal (18S), upper and lower container connector (13), connector valve (14) of the upper and lower system, insulating sleeve (15), upper level indicator (16), upper container surface with filter element (17), condenser connector (19), extractant solvent charging connector (20), solvent loading valve (21), sight glass (22), condensate diffusion and non-drip system (23), pressure meter and controller (P) constituting a safety system, thermocouples (T) and handles (40) for assembly and disassembly of the system.

FIG. 2. This figure shows a two-stages extraction equipment, wherein the upper body (2) further comprises an upper heating sleeve (6S) with means for controlling the temperature of the upper body (2).

FIG. 3. System for extraction and recovery of extract for a two-stage extraction equipment where there are shown extractor equipment (30), comprising an upper condenser (31S), a dryer concentrator (34), from which the extract (50) exits, and a lower condenser (31l), an upper solvent trap (32S) and a lower solvent trap (32l), an upper vacuum pump (33S) and a lower vacuum pump (33l).

FIG. 4. System for extraction and recovery of extract for a two-stage extraction equipment where there are shown extraction equipment (30), solvent vapor condenser (31), condensed solvent trap (32), vacuum pump (33), dryer concentrator (34), from which the extract (50) exits, safety valves (35), valves (36). The diagram of the extraction system is merely illustrative and does not correspond to an equipment layout diagram. The condensers, condensed solvents trap and vacuum pumps exposed can be common or independent equipment according to the operating requirements.

### DETAILED DESCRIPTION OF THE INVENTION

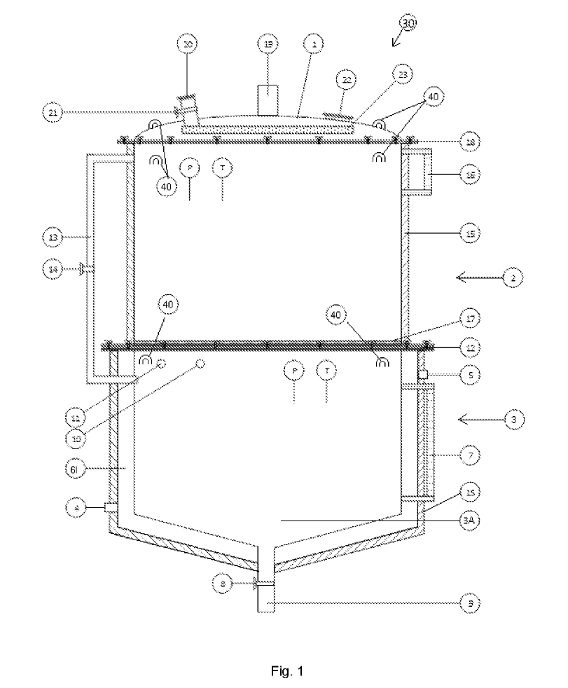

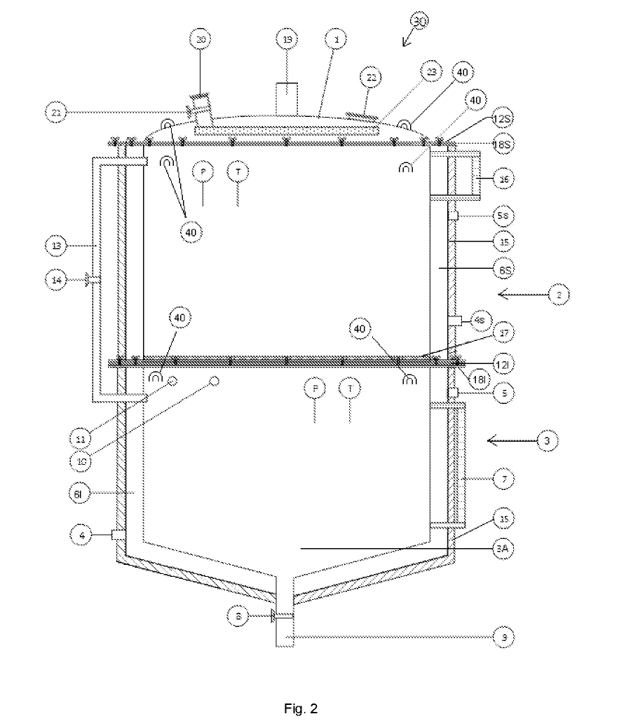

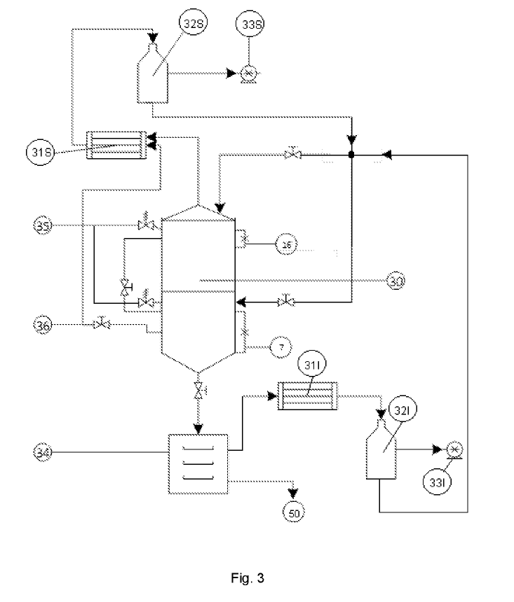

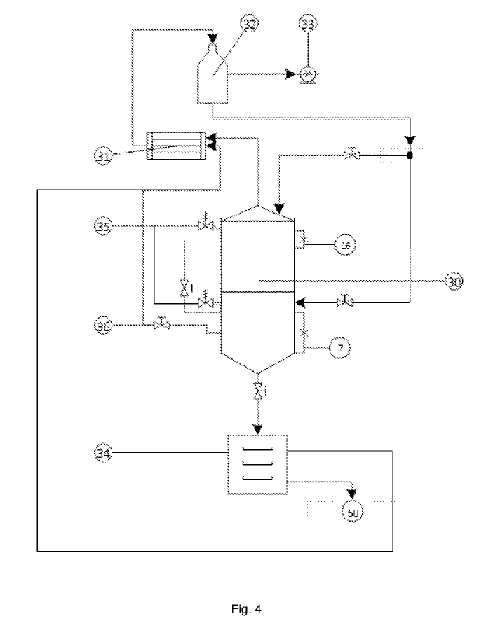

According to what is disclosed in FIGS. 1 to 4, the present technology refers to a solvent extraction equipment (30), which allows efficient use of energy, through the reuse of the solvent(s), with greater penetration and subsequent extraction of the compounds, increasing the amount of product obtained, which comprises:
an upper body (2) container of the solid material to be extracted, which at its base supports a filter element (17), which allows solvent vapors to pass towards the extraction source and the return of the extract and condensed solvent;
a lid (1) that joins the upper body (2) wherein the lid (1) comprises: a connection (19) to a condenser, an extractant solvent charging connector (20), an extractant solvent charging valve (21) and a condensate diffusion and non-drip system (23);
a lower body (3) container of the solvent/extract, comprising:
   a lower heating sleeve (6l), which comprises a means of temperature control;
   an inner chamber (3A) that is inside the lower heating sleeve (6l), comprising a connection valve to a vacuum and aeration connection subsystem (10) and a solvent loading valve (11), wherein the bottom of the inner chamber (3A) comprises a lower outlet pipe (9) passing through the lower heating sleeve (6l) at its bottom, where the lower outlet pipe (9) comprises a solvent/extract shut-off valve (8); and
a lower flange (12l) joining the bottom of the upper body (2) to the top of the lower body (3) container of the solvent/extract, wherein the lower flange (12l) further comprises a lower seal (18l) and a filter element (17), wherein the filter element (17) is a membrane or a fiberglass or ceramic filter or a mesh, wherein the mesh is made of teflon, stainless steel, copper, aluminum, steel or a mixture thereof, among other elements for the manufacture of a filter mesh.

The filter element (17) has a pore size of between at least 10 microns and up to 500 microns.

In a preferred embodiment, the upper body (2) and the lower body (3) container of the solvent/extract comprise an insulator (15), where this insulator is a thermal insulator, which can be Mineral Wool (rock wool), Expanded Polystyrene, Extruded Polystyrene, Polyurethane Foam, Phenolic Resin Foam, Glass Foam (glass wool), Wood Wool Slabs, Expanded Perlite Plates, Expanded Cork, Wood Fibers and other insulators that are at the outside or as insulation sleeve.

In another preferred embodiment the extraction equipment (30) further comprises a connection pipe (13) connecting the upper body (2) inside the inner chamber (3A) through the lower heating sleeve (6l), in where a upper/lower connection valve (14) interrupts the passage of fluid in the connection pipe (13).

The lid (1) further comprises a sight glass (22) and is joined to the upper body (2) by means of an upper flange assembly (12S), provided with an upper seal (18S) that prevents the solvent from coming out, wherein the upper body (2) further comprises an upper level indicator (16) and the lower body (3) container of the solvent/extract further comprises a load level indicator (7), wherein the upper body (2) further comprises a upper heating sleeve (6S) with means for controlling the temperature of the upper body (2).

The temperature control means are a lower inlet connection (4), a lower return or outlet connection (5) for the passage of a fluid for the temperature control of the lower heating sleeve (6l); and/or an upper inlet connection (4S), an upper return or outlet connection (5S) for the passage of a fluid for the temperature control of the upper heating sleeve (6S); or said temperature control means are an electric or induction heating system.

The upper body (2) and the lower body (3) container of the solvent/extract each comprise a pressure meter and controller or regulator (P) and a temperature meter (T), where, in a preferred embodiment, the upper body (2) and the lower body (3) container of the solvent/extract each comprise a safety system that consist of a bleed or purge valve (35), wherein, the temperature gauge (T) is a thermocouple

The solvent extraction equipment (30) is made of brass, steel, stainless steel, copper, glass, aluminum, or a mixture thereof or other suitable material.

In order to facilitate its assembly and disassembly, the extraction equipment (30), further comprises handles (40), for disassembling the lid (1), the upper body (2) and/or the lower body (3) container of the solvent/extract, for their cleaning and maintenance.

In another preferred embodiment, the extraction equipment (30), further comprises second filters located in the upper level indicator (16) and/or in the connection pipe (13), to prevent entry of the particulate and obstruction of its ducts.

A solvent extraction system comprising: the solvent extraction equipment (30), and
an upper condenser (31S) of solvent vapors, which is connected with a condenser connector (19) with a lid (1) of the extraction equipment (30);
an upper solvent trap (32S) which is connected to the upper condenser (31S) and a solvent inlet connector (20), where the solvent vapors are condensed, by the lowering of pressure generated by a upper vacuum pump (33S).

In a preferred embodiment, the system further comprises:
a dryer (34) which is connected to a solvent/extract shut-off valve (8) of the extraction equipment (30);
a lower condenser (31l) of solvent vapors, which is connected to the dryer (34); and
a lower solvent trap (32l) which is connected to the lower condenser (31l) and a solvent inlet connector (20), where the solvent vapors are condensed, by the lowering of pressure generated by a lower vacuum pump (33l), to obtain an extract with traces of solvent.

In order to prevent overpressure, the system further comprises: safety valves (35) that allow to avoid overpressures of the system and extraction equipment (30), where some condenser valves (36) that connect to a vacuum and aeration connection subsystem (10) and the upper condenser (31S), to regulate the system pressure.

In order to lower operating and infrastructure costs, the upper capacitor (31S) and the lower capacitor (31l) are a same capacitor (31); the upper solvent trap (32S) and the lower solvent trap (32l) are a same solvent trap (32); and the upper vacuum pump (33S) and the lower vacuum pump (33l) are a same vacuum pump (33).

A method of extraction by solvent, comprising:

a. selecting the solvent with respect to the extraction source or raw material (matrix) to separate and determining the amount of solvent;

b. selecting the working temperature with respect to the solvent, which corresponds to at least the boiling temperature of the solvent at the working pressure, to generate the boiling of the solvent;

c. entering the extraction source to the upper body (2) by the lid (1) and the solvent to the solvent/extract container (3) by the dual purpose valves (11, 10) or a extractant solvent charging connector (20) through a condensate diffusion and non-drip system (23);

d. heating the lower body (3) container of the solvent/extract until reaching the selected working temperature, by means of the entry of a fluid through the lower inlet connection (4) or by means of a heating system inside a lower heating sleeve (6l) which is for the passage of a fluid or to house an electric or induction heating system;

e. controlling the temperature in the lower body (3) container of the solvent/extract by means of the entry of hot or cold fluid by the lower inlet connection (4) to the lower heating sleeve (6l) and the exit of fluid by a lower return or outlet connection (5) or by means of activating or deactivating the heating system;

f. controlling the working pressure through at least one meter and controller for pressure (P), to maintain the pressure at a value less than or equal to 1.25 times the vapor pressure of the solvent;

g. starting the extraction stage of the extract, wherein the extract is transferred to the base and accumulates in the lower body (3) container of the solvent/extract, finishing a work cycle;

h. maintaining the operating temperature and pressure selected for at least 3 operation cycles;

i. obtaining the extracted extract, by opening a solvent/extract shut-off valve (8).

In a preferred embodiment of step a) the selected solvent has a liquid phase density of less than 997 kg/m³.

In another preferred embodiment of step a) the amount of solvent selected has a weight ratio with the amount of solid matter to be extracted from at least 0.5 kg of solvent per 1 kg of extraction source.

In a preferred embodiment of step e) it further comprises reducing or controlling the temperature of the inner chamber (3A), to cause the transfer of the extract from the upper compartment (2) to said inner chamber (3A) by decreasing the temperature, in the lower heating sleeve (6l).

Reducing or controlling the temperature of the inner chamber (3A), which is achieved by means of entering a cooling fluid through the lower inlet connection (4) and transferring the fluid inside the lower heating sleeve (6l), which exits through the lower return or outlet connection (5), or by means of disconnection of the heating system inside the lower heating sleeve (6l).

In a preferred embodiment of step f) it further comprises controlling the pressure of the lower body (3) container of the solvent/extract, to cause the transfer of the extract from the upper compartment (2) to the solvent/extract compartment (3) through the filter material (17).

In another preferred embodiment of step f) it further comprises reducing or controlling the pressure of the lower body (3) container of the solvent/extract, through a vacuum pump connected to the pressure meter and controller (P) in order to cause the fall and transfer of the extract from the upper compartment (2) to the lower compartment (3).

In another preferred embodiment of step f) it further comprises reducing, controlling and equalizing the pressures of the lower body (3) container of the solvent/extract, with the upper body (2) container of the extraction source, to cause the transfer of the extract through the filter due to gravity. This is achieved by a connection pipe (13) comprising a upper/lower connection valve (14).

In another preferred embodiment of steps e) and f) further comprise controlling the pressure and temperature jointly.

In another preferred embodiment of steps e) and f) further comprises controlling the pressure and temperature independently, subsequently to set operating variables of pressure, solvent vapor temperature, extraction source amount and number of cycles to be performed, which is done by computational means, PLC, or other control means, which can be wired or wireless.

In a preferred embodiment of step g) it further comprises generating a bubbling of the solid material and condensed solvent together to obtain the desired extract.

In another preferred configuration of step g) also comprises capturing the solvent vapors passing through the extraction source which is in the upper body (2), in an upper condenser (31S), condenses and returns the solvent in a liquid way through the extractant solvent charging connector (20), diffusing it through the condensate diffusion and non-drip system (23) to the upper body (2) of the extraction equipment (30); wherein, the solvent vapors pass through the filter element (17) and the solid material source of extraction.

### APPLICATION EXAMPLES

### Example 1

In a first instance, this type of extractor was elaborated on a laboratory scale made of glass with fiberglass of different pore sizes and capacities that allowed to hold the solid source of extraction in a volume of 50, 100, 250 and 1.500 ml (4 different systems). This extractor, allows its connection to accumulator and condensers to complete the system. The actual amount of sample to be treated is related to the density of the solid sample (source to be extracted), which will also depend on the size of the particles contained in said material.

This equipment has been successfully tested with the use of solvents such as water, acetone, ethanol, isopropyl alcohol, petroleum ether, hexane and cyclohexane. Under diverse solid sources of extraction as: leaves, husks, fruits and flours of animal origin with protein content. Additionally, tests have been carried out that allow successive extractions with solvents such as water and alcohol and vice versa, which gives signals that it is possible to obtain different fractions of products from the same extraction source, these fractions of compounds being compatible and soluble in the solvent used at the working temperature. From these extractions has been obtained, antioxidants, pigments, oils and mixtures of these.

The extractor equipment object of this patent was submitted to a comparison of its extraction efficiency at laboratory scale with three known systems such as the Soxhlet system, contact extraction (maceration) at boiling temperature of the solvent and the alembic system, under the same working conditions and extraction times. For all cases, the extraction times of the Soxhlet system from the first drop of solvent that falls on the extraction source until the fall of the extract were considered as reference.

Although extractions were made with the alembic system, the trials did not provide results that would allow comparisons to be made, because, for the conditions used, the masses of the extraction products were not appreciable. This is related to fact that the system has volatile solvents, such as alcohols and ketones, the operation of this system behaves like a simple distillation.

The comparison process consisted in subjecting to extraction organic matter from agricultural industry discards, with an approximate mass of 50 g, which are subjected to extraction with 200 g of each solvent (water, ethanol and acetone), under the same conditions of contact time between solvent and sample, considering the extraction times presented by Soxhlet system as reference.

Table 1. Corresponds to a comparative table, which shows the percentages of mass extracted from two types of matrices, one of animal origin and the other vegetable, which were subjected to extraction with three types of solvents. That is, the percentage results of the amount of solid matter recovered for the extraction trials for the Soxhlet system, contact extraction system (maceration) and the two-stages extraction system of this patent are presented.

TABLE 1

| | | | | | Two-stages |
|---|---|---|---|---|---|
| | | | | | extraction |
| | | | Soxhlet | By contact or | system- |
| | | | system | maceration | Patent- |
| Solvent | Sample | Time | (%) | (%) | (%) |
| Water | A | t1 | 0.169 | 0.335 | 0.438 |
| | | t2 | 0.068 | 0.123 | 0.152 |
| | | Total | 0.237 | 0.458 | 0.591 |
| Acetone | A | t1 | 0.124 | 0.200 | 0.221 |
| | | t2 | 0.066 | 0.012 | 0.014 |
| | | t3 | 0.002 | 0.002 | 0.006 |
| | | Total | 0.192 | 0.214 | 0.241 |
| | B | t1 | 5.657 | — | 6.031 |
| | | t2 | 0.873 | — | 0.908 |
| | | Total | 6.530 | — | 6.939 |
| Ethanol | A | t1 | 0.307 | 0.311 | 0.438 |
| | | t2 | 0.162 | 0.139 | 0.183 |
| | | t3 | 0.116 | 0.078 | 0.163 |
| | | Total | 0.585 | 0.528 | 0.785 |
| | B | t1 | 5.225 | — | 5.583 |
| | | t2 | 1.236 | — | 1.059 |
| | | Total | 6.460 | — | 6.641 |

In Table 1 it can be appreciated the solvents used against two types of matrices named as A and B corresponding to plant leaves and crustacean flour respectively, for different times of cumulative extraction t1 (10 min), t2 (15 min) and t3 (20 min) respectively. From Table 1 it can be seen that the two-stages extractor presents a greater amount of solid product from the first extraction and for the total of these, indistinctly of the solvent used, surpassing the Soxhlet system with values closer to the extraction by contact without the complications that this presents in the subsequent processes of transfer, recovery and concentration of said extracts. It was established that the amount of material recovered by the two-stages extraction system in the time lapse evaluated shows positive differences ranging from 0.2 to 0.4% of material recovered. The amount of total material recovered will depend on the extraction source, the solvent used and the interactions with compounds to be extracted.

### Example 2

Once the feasibility of extraction with laboratory scale systems was established, an extraction equipment of stainless steel was made, allowing treatment of about 7 liters of solvent and 7 liters of solid extraction source (note that the amount of matter is related to its density and the amount of material necessary to fill the container volume). This equipment allowed the addition of implements such as level indicators, hose connections, valves and control systems (temperature and pressure) that facilitate the handling and control of extraction on a larger scale, as well as allowing the use of vacuum in said system. This prototype, that allowed to add new implements to the system, was tested by using solvents such as water, acetone and ethanol on matrices such as plant leaves and crustacean flours, obtaining products with a high content of polyphenols, antioxidants, pigments and essential fatty acids. This equipment allowed us to make an approximation to the behavior that the extraction sources of different origin and nature can present along with the solvents and the filtering material.

At the prototype scale, it have been performed extractions from leaves and crustacean flours, with the use of solvents such as water, ethanol and acetone, obtaining mixtures of antioxidants, pigments and oils, showing yields that vary with the solvent used and the type of product obtained.

### Example 3

Once the necessary modifications were established at the prototype scale, a pilot-scale stainless steel equipment was built. Said equipment has a capacity of 250 liters for both the solid extraction source container (2) and the solvent/extract container (3). This equipment was provided with heating and cooling sleeves, manometers, thermocouples, hoses with quick connections, level indicators, valves and relief valve (overpressure), non-drip device, solvent and condensate diffuser, in addition to the necessary connections to incorporate condensation, pumping and vacuum systems.

One of the most important aspects corresponds to the energy requirement that allows the evaporation of the solvent to be used. This will vary with the solvent to be used, making necessary a higher energy consumption at a higher boiling temperature of the solvent and the interactions that may occur with the extracted compounds. The working temperature can be reduced by using vacuum, so that enabling pressure reduction within the system with the consequent decrease of the amount of energy required to reach the boiling point of the pure solvent or the extract.

At pilot scale extractions was performed on crustacean flours using ethanol and acetone as extractant solvent. From the extractive processes, different products have been obtained, among which stand out an orange/red oil corresponding to fatty acids with astaxanthin, which is the pigment that gives the orange color to crustaceans. As an example, the extraction equipment with the use of acetone has allowed to obtain a concentrated extract corresponding to an oil with reddish pigment (Astaxanthin) with values ranging from 5 to 20% of acetone, which is related to the amount of material used and the time of concentration. This product can then be concentrated or dried by another system. Finally, it was possible to obtain a total of 3.2-5.2 kg of said oil, corresponding to the product of the treatment of between 100 kg and 150 kg of crustaceans flour. It should be noted that the differences are influenced by the heterogeneity that may present the natural sources to which extractions are required to perform, but generally, the analysis of fat content by Soxhlet have given values of fat content of approximately 3.8%. The difference may be due to the type of solvent used for the determination of fatty acids and the type of material contained in the extract with acetone.

1. A solvent extraction equipment (30), which allows efficient use of energy, through the reuse of the solvent(s), with greater penetration and subsequent extraction of the compounds, increasing the amount of product obtained, CHARACTERIZED in that comprises:
an upper body (2) container of the solid material to be extracted, which comprises a filter element (17);
a lid (1) that joins the upper body (2) wherein the lid (1) comprises: a condenser connection (19), an extractant solvent charging connector (20), an extractant solvent charging valve (21) and a condensate diffusion and non-drip system (23);
a lower body (3) container of the solvent/extract, comprising:
a lower heating sleeve (6l), which comprises a means of temperature control;
an inner chamber (3A) that is inside the lower heating sleeve (6l), comprising a connection valve to a vacuum and aeration connection subsystem (10) and a solvent loading valve (11), wherein the bottom of the inner chamber (3A) comprises a lower outlet pipe (9) passing through the lower heating sleeve (6l) at its bottom, where the lower outlet pipe (9) comprises a solvent/extract shut-off valve (8); and
a lower flange (12l) joining the bottom of the upper body (2) to the top of the lower body (3) container of the solvent/extract, wherein the lower flange (12l) further comprises a lower seal (18l).

2. The solvent extraction equipment (30) according to claim 1, CHARACTERIZED in that the filter element (17) is a membrane.

3. The solvent extraction equipment (30) according to claim 1, CHARACTERIZED in that the filter element (17) is a fiberglass or ceramic filter.

4. The solvent extraction equipment (30) according to claim 1, CHARACTERIZED in that the filter element (17) is a mesh.

5. The solvent extraction equipment (30) according to claim 4, CHARACTERIZED in that the mesh is made of teflon, stainless steel, copper, aluminum, steel or a mixture thereof.

6. The solvent extraction equipment (30) according to claim 1, CHARACTERIZED in that the filter element (17) has a pore size of between at least 10 microns and up to 500 microns.

7. The solvent extraction equipment (30) according to claim 1, CHARACTERIZED in that the upper body (2) and the lower body (3) container of the solvent/extract comprise an insulator (15).

8. The solvent extraction equipment (30) according to claim 1, CHARACTERIZED in that further comprises a connection pipe (13) connecting the upper body (2) inside the inner chamber (3A) through the lower heating sleeve (6l), in where a upper/lower connection valve (14) interrupts the passage of fluid in the connection pipe (13).

9. The solvent extraction equipment (30) according to claim 1, CHARACTERIZED in that the lid (1) further comprises a sight glass (22) and is joined to the upper body (2) by means of an upper flange assembly (12S), provided with an upper seal (18S) that prevents the solvent from coming out.

10. The solvent extraction equipment (30) according to claim 1, CHARACTERIZED in that the upper body (2) further comprises an upper level indicator (16) and the lower body (3) container of the solvent/extract further comprises a load level indicator (7).

11. The solvent extraction equipment (30) according to claim 1, CHARACTERIZED in that the upper body (2) further comprises a upper heating sleeve (6S) with means for controlling the temperature of the upper body (2).

12. The solvent extraction equipment (30) according to claim 1 or 11, CHARACTERIZED in that the temperature control means are a lower inlet connection (4), a lower return or outlet connection (5) for the passage of a fluid for the temperature control of the lower heating sleeve (6l); and/or an upper inlet connection (4S), an upper return or outlet connection (5S) for the passage of a fluid for the temperature control of the upper heating sleeve (6S); or said temperature control means are an electric or induction heating system.

13. The solvent extraction equipment (30) according to claim 1, CHARACTERIZED in that the upper body (2) and the lower body (3) container of the solvent/extract each comprise a pressure meter and controller or regulator (P) and a temperature meter (T).

14. The solvent extraction equipment (30) according to claim 1, CHARACTERIZED in that the upper body (2) and the lower body (3) container of the solvent/extract each comprise a safety system that consist of a bleed or purge valve (35).

15. The solvent extraction equipment (30) according to claim 13, CHARACTERIZED in that the temperature meter (T) is a thermocouple.

16. The solvent extraction equipment (30) according to claim 1, CHARACTERIZED in that it is made of brass, steel, stainless steel, copper, glass, aluminum, or a mixture thereof

17. The solvent extraction equipment (30) according to claim 1, CHARACTERIZED in that further comprises handles (40), for disassembling the lid (1), the upper body (2) and/or the lower body (3) container of the solvent/extract, for their cleaning and maintenance.

18. The solvent extraction equipment (30) according to claim 1 or 8, CHARACTERIZED in that further comprises second filters located in the upper level indicator (16) and/or in the connection pipe (13), to prevent entry of the particulate and obstruction of its ducts.

19. A solvent extraction system comprising the solvent extraction equipment (30), which allows efficient use of energy, through the reuse of the solvent(s), with greater penetration and subsequent extraction of the compounds, increasing the amount of product obtained, according to claim 1, CHARACTERIZED in that comprises:
an upper condenser (31S) of solvent vapors, which is connected with a condenser connector (19) with a lid (1) of the extraction equipment (30);
an upper solvent trap (32S) is connected to the upper condenser (31S) and a solvent inlet connector (20), where the solvent vapors are condensed, by the lowering of pressure generated by a upper vacuum pump (33S).

20. The solvent extraction system, according to claim 19, CHARACTERIZED in that it also comprises:
a dryer (34) which is connected to a solvent/extract shut-off valve (8) of the extraction equipment (30);
a lower condenser (31l) of solvent vapors, which is connected to the dryer (34); and
a lower solvent trap (32l) which is connected to the lower condenser (31l) and a solvent inlet connector (20), where the solvent vapors are condensed, by the lowering of pressure generated by a lower vacuum pump (33l), to obtain an extract with traces of solvent.

21. The solvent extraction system, according to claim 19, CHARACTERIZED in that further comprises: safety valves (35) that allow to avoid overpressures of the system and extraction equipment (30).

22. The solvent extraction system, according to claim 19, CHARACTERIZED in that further comprises: condenser valves (36) that connect to a vacuum and aeration connection subsystem (10) and the upper condenser (31S), to regulate the system pressure.

23. The solvent extraction system, according to claims 19 and 20, CHARACTERIZED in that the upper capacitor (31S) and the lower capacitor (31l) are a same capacitor (31); the upper solvent trap (32S) and the lower solvent trap (32l) are a same solvent trap (32); and the upper vacuum pump (33S) and the lower vacuum pump (33l) are a same vacuum pump (33).

24. A method of extraction by solvent, which allows efficient use of energy, through the reuse of the solvent(s), with greater penetration and subsequent extraction of the compounds, increasing the amount of product obtained, CHARACTERIZED in that comprises:
a. selecting the solvent with respect to the extraction source or raw material to separate and determining the amount of solvent;
b. selecting the working temperature with respect to the solvent, which corresponds to at least the boiling temperature of the solvent at the working pressure, to generate the boiling of the solvent;
c. entering the extraction source to the upper body (2) by the lid (1) and the solvent to the solvent/extract container (3) by the dual purpose valves (11, 10) or a extractant solvent charging connector (20) through a condensate diffusion and non-drip system (23);
d. heating the lower body (3) container of the solvent/extract until reaching the selected working temperature, by means of the entry of a fluid through the lower inlet connection (4) or by means of a heating system inside a lower heating sleeve (6l) which is for the passage of a fluid or to house an electric or induction heating system;
e. controlling the temperature in the lower body (3) container of the solvent/extract by means of the entry of hot or cold fluid by the lower inlet connection (4) to the lower heating sleeve (6l) and the exit of fluid by a lower return or outlet connection (5) or by means of activating or deactivating the heating system;
f. controlling the working pressure through at least one meter and controller for pressure (P), to maintain the pressure at a value less than or equal to 1.25 times the vapor pressure of the solvent;
g. starting the extraction stage of the extract, wherein the extract precipitates on the base and accumulates in the lower body (3) container of the solvent/extract, finishing a work cycle;
h. maintaining the working temperature and pressure selected for at least 3 operation cycles;
i. obtaining the extracted extract, by opening a solvent/extract shut-off valve (8).

25. The method of extraction by solvent, according to claim 24, CHARACTERIZED in that in step a) the selected solvent has a liquid phase density of less than 997 kg/m³.

26. The method of extraction by solvent, according to claim 24, CHARACTERIZED in that in step a) the amount of solvent selected has a weight ratio with the amount of solid material of at least 0.5 kg of solvent per 1 kg of the extraction source.

27. The method of extraction by solvent, according to claim 24, CHARACTERIZED in that the step e) further comprises reducing or controlling the temperature of the inner chamber (3A), to cause the transfer of the extract from the upper compartment (2) to said inner chamber (3A) by decreasing the temperature, in the lower heating sleeve (6l).

28. The method of extraction by solvent, according to claim 24, CHARACTERIZED in that reducing or controlling the temperature of the inner chamber (3A) is by means of entering a cooling fluid through the lower inlet connection (4) and transferring the fluid inside the lower heating sleeve (6l), which exits through the lower return or outlet connection (5), or by means of disconnection of the heating system inside the lower heating sleeve (6l).

29. The method of extraction by solvent, according to claim 24, CHARACTERIZED in that step f) further comprises controlling the pressure of the lower body (3) container of the solvent/extract, to cause the transfer of the extract from the upper compartment (2) to the solvent/extract compartment (3) through the filter material (17).

30. The method of extraction by solvent, according to claim 24, CHARACTERIZED in that step f) further comprises reducing or controlling the pressure of the lower body (3) container of the solvent/extract, through a vacuum pump connected to the pressure meter and controller (P) in order to cause the fall and transfer of the extract from the upper compartment (2) to the lower compartment (3).

31. The method of extraction by solvent, according to claim 24, CHARACTERIZED in that step f) further comprises reducing, controlling and equalizing the pressures of the lower body (3) container of the solvent/extract, with the upper body (2) container of the extraction source, to cause the transfer of the extract through the filter due to gravity, by means of a connection pipe (13) comprising a upper/lower connection valve (14).

32. The method of extraction by solvent, according to at least one of claims 24 to 3 1, CHARACTERIZED in that steps e) and f) further comprise controlling the pressure and temperature jointly.

33. The method of extraction by solvent, according to at least one of claims 24 to 32, wherein steps e) and f) further comprises controlling the pressure and temperature independently, subsequently to set operating variables of pressure, solvent vapor temperature, solid material amount and number of cycles to be performed.

34. The method of extraction by solvent, according to claim 24, characterized in that step g) further comprises generating a bubbling of the extraction source set and condensed solvent, to obtain the desired extract.

35. The method of extraction by solvent according to claim 24 or 34, CHARACTERIZED in that step g) also comprises capturing the solvent vapors passing through the extraction source which is in the upper body (2), in an upper condenser (31S), condenses and returns the solvent in a liquid way through the extractant solvent charging connector (20), diffusing it through the condensate diffusion and non-drip system (23) to the upper body (2) of the extraction equipment (30); wherein, the solvent vapors pass through the filter element (17) and the extraction source.
